(19) United States
(12) Patent Application Publication
(10) Pub. No.: US 2007/0058752 A1
(43) Pub. Date: Mar. 15, 2007

(54) Methods and systems for estimating sampling frequency offset of OFDM symbols

(75) Inventor: Chun-Nan Ke, Taichung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Faraday Technology Corp.

(21) Appl. No.: 11/193,223

(22) Filed: Jul. 29, 2005

(51) Int. Cl. H04L 27/00

(52) U.S. Cl. 375/316

(57) ABSTRACT

A method for obtaining sampling frequency offset of an Orthogonal Frequency Division Multiplexed symbol in an OFDM receiver. The method comprises obtaining a first series of pilot pairs, wherein each pilot pair is symmetric with a dc point of a frequency axis, and each pilot pair has a first pilot value, obtaining a first difference of each pilot, obtaining a first group difference, wherein the first group difference is a summation of the first differences of the first series, and obtaining SFO information by obtaining difference between real and image parts of the first group difference.

### BACKGROUND

The invention relates to Orthogonal Frequency Division Multiplexing (OFDM), and more particularly, to estimating sampling frequency offset of an OFDM symbol.

In wireless communication systems, a signal may be sent at a certain frequency within a transmission path. Recent developments have enabled the simultaneous transmission of multiple signals over a single transmission path. One of these methods of simultaneous transmission is Frequency Division Multiplexing (FDM). In FDM, the transmission path is divided into sub-channels. Information (e.g. voice, video, audio, text, data, etc.) is modulated and transmitted over the sub-channels at different sub-carrier frequencies.

A particular type of FDM is Orthogonal Frequency Division Multiplexing (OFDM). In a typical OFDM transmission system, there are 2N+1 OFDM sub-carriers, including the zero frequency DC sub-carrier, not generally used to transmit data since it has no frequency. An OFDM system forms its symbol by taking k complex QAM symbols Xₖ, each modulating a sub-carrier with frequency fₖ=k/Tᵤ, where Tᵤ is the sub-carrier symbol period. Each OFDM sub-carriers displays a sinc x=(sin x)/x spectrum in the frequency domain. By spacing each of the 2N+1 sub-carriers 1/Tᵤ apart in the frequency domain, the primary peak of each sub-carrier's sinc x spectrum coincides with a null of the spectrum of every other sub-carrier. In this way, although the spectra of the sub-carriers overlap, they remain orthogonal to one another. An advantage of OFDM technology is that it is generally able to overcome multiple path effects. Another advantage of OFDM technology is that it is typically able to transmit and receive large amounts of information. Because of these advantages, much research has been reported to advance OFDM technology.

Although OFDM exhibits these advantages, conventional implementations of OFDM also present several difficulties and practical limitations. The most significant difficulty implementing OFDM transmission systems is that of achieving timing and frequency synchronization between the transmitter and the receiver. One of the issues of synchronization is sampling frequency offset (SFO), requiring careful attention for the proper reception of OFDM signals.

The sampling frequency offset issue is related to synchronization between the transmitter's sample rate and the receiver's sample rate, eliminating sampling frequency offset. Any mismatch between the two sampling rates can result in a rotation of the k sub-carriers constellation.

FIG. 1 shows the problem of sampling frequency offset. The transmitter and receiver each have digital clocks with oscillators, which can never be exactly synchronized. The effect of the offset gets worse over time.

The general principles of OFDM signal reception can be described with reference to FIG. 2, a block diagram of a conventional SFO recovery structure. r(t) is sampled by analog/digital converter (ADC) at an interval of \tilde{T}=(1+ζ)T, where T is the sampling period at the transmitter, and ζ is the sampling frequency offset. \tilde{T} is a fixed value, decided by a crystal oscillator. A FFT module is coupled to the ADC, for Fourier transformation of the OFDM symbol into a frequency domain. Digital phase lock loop (DPLL) recovers the SFO of sub-carriers. Phase detector in the DPLL is used to estimating SFO. If the phase of the sub-carrier rotates more than one point of an OFDM symbol, rob/stuff module discards or interprets a point of an OFDM symbol. Conventional approaches of estimating the sampling frequency offset rely on pilot sub-carriers. Pilots comprise a sequence of frequencies in which pre-determined value is transmitted, so that an OFDM receiver can use the pilot value to perform synchronization functions. Typical sampling frequency offset estimator solves the formula of

$$ζ = \frac{{T}_{u}}{2 π {T}_{s} ( {min}_{k ∈ {C}_{2}} ( k ) + {max}_{k ∈ {C}_{2}} ( k ) )} ( {ϕ}_{2 , l} - {ϕ}_{1 , l} ) ,$$

where C1 corresponds to pilots on negative sub-carriers, C2 corresponds to pilots on positive sub-carriers, φ_{1,l} is angle of

$${\sum }_{k ∈ {C}_{2}} {Z}_{l , k} ,$$

and φ_{2,l} is the angle of

$${\sum }_{k ∈ {C}_{1}} {Z}_{l , k} ,$$

where Z_{l,k}=R_{l,k}R*_{l-1,k}, R_{l,k} is received pilot sub-carrier, l is the symbol index, and k is subcarrier index. The computation of ζ requires many of complex multipliers, arc tangent units, and dividers.

In United States Patent Application No. 20040131012, Moby et al. suggest a technique for detecting and correcting SFO of an OFDM receiver using early-late pilot correlation method. The method, however, requires complex multipliers to accomplish correlation. Aswell, Moby's technique requires two square calculations to estimate SFO, thereby rendering the technique computationally complex.

In U.S. Pat. No. 5,608,764, Sugita et al. present a method for improved demodulation of OFDM signals. This technique use +/− sign to simplify hardware design. However, the accuracy is lost because only the sign is taken. Also, the disclosure requires two symbol durations to synchronize with the OFDM signal. Furthermore, the method requires complex multiplication.

In U.S. Pat. No. 6,628,735, Belotserkovsky et al. disclose a method for correcting the sampling frequency offset of an OFDM receiver. The method uses null sub-carrier magnitude difference to estimate SFO. The success of this method is limited on the pilot carriers must be surrounded by nulls. Additionally, the method requires square calculation, thus increasing the area of SFO estimator.

In U.S. Pat. No. 6,359,938, Keevill et al. also provides method of recovering OFDM symbols. The method uses Taylor Series to approximated arctangent calculation. Similarly, dividers and complex multipliers are required, whereby circuit size is increased.

In “A Integrated OFDM Receiver for High-speed Mobile Data Communications,” IEEE Global Telecommunications Conference, no. 1, November 2001 pp. 3090-3094, Zou discusses techniques for OFDM synchronization. The methods measure adjacent sub-carrier in an OFDM symbol to estimate SFO. This technique requires complex multiplication, arctangent calculator, and divider, and is, therefore, tremendously computationally complex. Accordingly, there is a need for a method or system that can detect and correct the SFO in an efficient way.

### SUMMARY

Methods of estimating SFO of an OFDM symbol are disclosed. The method comprises obtaining a first and second series of pilot pairs, wherein each pilot pair is symmetric with a dc point of a frequency axis, and the first pilot series has a first pilot value, while the second pilot series has a second pilot value, and the ratio of the first pilot value to the second pilot value is −1, obtaining a first difference for each pilot pair, obtaining a first group difference, wherein the first group difference is a sum of the first differences of the first series, obtaining a second group difference, wherein the second difference is the sum of the first difference of the second series, obtaining a third group difference of the first and the second group difference, and obtaining SFO information by taking the difference between real and imaginary parts of the third group difference.

In another embodiment of the invention, the method further comprises comparing pilot magnitude of each pilot pair; discarding the pilot pair(s) if the result of comparison exceeds a pre-determined value, and obtaining the first and second group difference according to the compared results.

Systems for estimating SFO of an OFDM symbol are also provided. An embodiment of such a system comprises two subtractor arrays, two adders, and two subtractors.

A first array processes a first series of pilot pairs by calculating the difference for each pilot pair. The first series has a first pilot value, and every pilot pair is symmetric with a dc point of a frequency axis. A second subtractor array processes second series pilot pair by calculating the difference of each pilot pair of the second series. Each pair of the second series is symmetric with the dc point of the frequency axis, and the second series has a second pilot value. The ratio of the first pilot value to the second pilot value is −1. A first adder sums the differences of the first series to acquire a first group difference. A second adder sums the differences of the second series to acquire a second group difference. A first subtractor calculates difference between the first and second group difference to acquire a third group difference. A first processing unit acquires real and imaginary parts of the third group difference, respectively. A second subtractor calculates the difference between the real and imaginary parts of the third group difference.

In another embodiment of the invention, the system further comprises a pilot selection module. The pilot selection module comprises a magnitude comparator and a selection module. The magnitude comparator compares pilot magnitude of each pilot pair. The selection module selects and discards pair(s) according to the output of the magnitude comparator.

### BRIEF DESCRIPTION OF THE DRAWINGS

FIG. 1 illustrates sampling frequency offset;

FIG. 2 is a block diagram of a conventional SFO recovery structure;

FIG. 3 shows an OFDM symbol with pilot pattern;

FIG. 4 is a schematic diagram of a SFO estimator in a PLL module;

FIG. 5 is a structural diagram of the SFO estimator;

FIG. 6a, 6b, 6c show transmission channel attenuating the pilots;

FIG. 7 is a diagram of pilot selection;

FIG. 8 is a diagram of pilot selection hardware combined with a SFO estimator;

FIG. 9 is a flowchart of a method for estimating SFO according to embodiments of the invention; and

FIG. 10 is a flowchart of a pilot selection method according to embodiments of the invention.

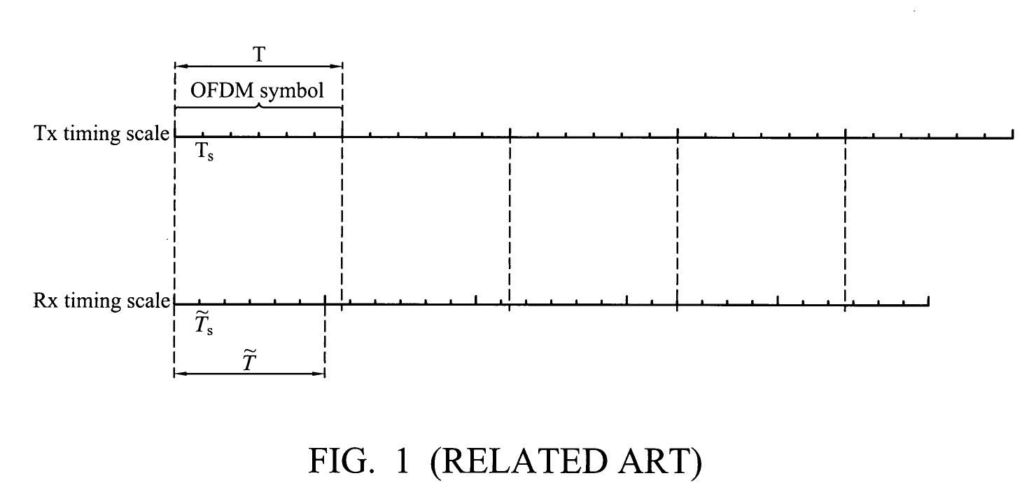

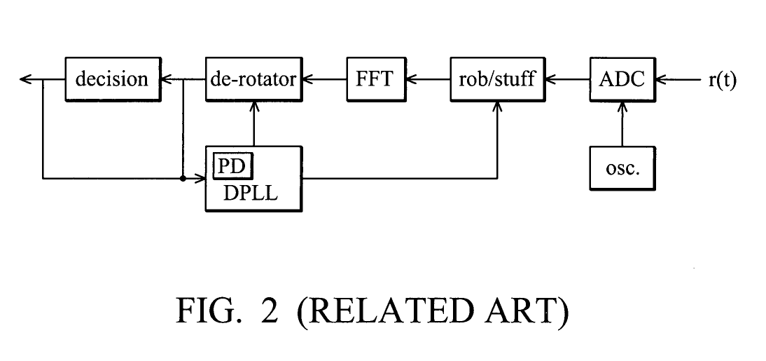

### DETAILED DESCRIPTION

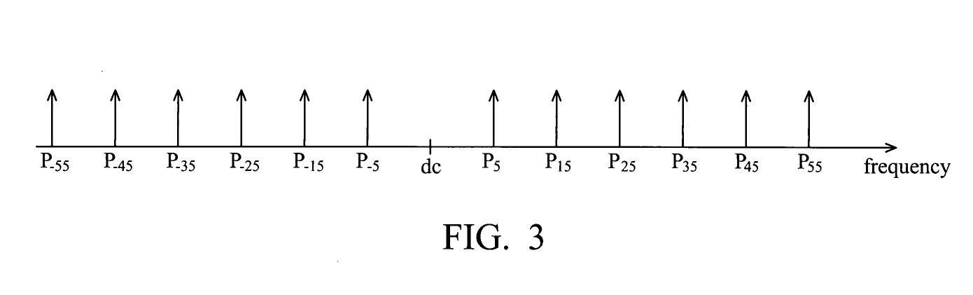

Pilots comprise a sequence of frequencies in which known data is transmitted. This sequence is usually a pseudo-random sequence. In an embodiment of the invention, Ultra Wide Band (UWB) standards are adapted. FIG. 3 shows an OFDM symbol with pilot pattern. Dedicated pilots are embedded in the 5^{th}, 15^{th}, 25^{th}, 35^{th}, 45^{th} and 55^{th} sub-carriers. The pilot symbols are 4-QAM modulated and derived from the pseudo-random sequence.

SFO leads to phase rotation of sub-carriers. The phase rotation of kth pilot is proportional to sub-carrier index k. For example, if P₅ (5th positive sub-carrier of an OFDM symbol) has a rotation angle e^{j5Δ}, then P₋₅ (5th negative sub-carrier of an OFDM symbol) has a rotation angle e^{j-5Δ}. Phase rotation caused by SFO is symmetrical with respect to the DC point of frequency axis.

The sampling frequency offset can be derived by acquiring difference of a pilot pair. For example, P₅₅ and P₋₅₅ are 55^{th} positive and negative sub-carriers of an OFDM symbol, respectively, wherein the difference of the pilot pair is:

$$\begin{matrix}{P}_{55} - {P}_{- 55} = P \cdot {ⅇ}^{j55Δ} - P \cdot {ⅇ}^{- j55Δ} \\ = P ( {ⅇ}^{j55Δ} - {ⅇ}^{- j55Δ} ) \\ = P ( 2 jsin ( 55 Δ ) ) .\end{matrix}$$

$$if$$

$$P = 1 + j , \\ then$$

$${P}_{55} - {P}_{- 55} = 2 ( sin ( 55 Δ ) - jsin ( 55 Δ ) ) .$$

Assuming 55Δ<5°, sin(55Δ)≈55Δ, then
P₅₅−P₅₅=110Δ−j110Δ,
thus, Δ=Re{P₅₅−P₋₅₅}−Im{P₅₅−P₋₅₅})/220, wherein Δ contains information of SFO.

The assumption that 55 Δ is a small angle is reasonable because of the following formulas:

At SFO of 100 ppm, a normal condition of OFDM transmission,

$${P}_{55} = P \cdot {ⅇ}^{j2π55ζ \frac{{T}_{S}}{{T}_{U}}} ,$$

then

$$55 Δ = 2 π \cdot 55 \cdot 100 ppm \cdot \frac{165}{128} ≅ 03045 ( radian ) = 0.28 ° ,$$

thus,
assuming that 55Δ less than 5° is logical.

Pilot sequence is grouped by their values. In the embodiment of the invention, a first series pilot pair, P₅ and P₋₅, P₁₅ and P₋₁₅, P₃₅ and P₋₃₅, and P₄₅ and P₋₄₅, has the same pilot value P, while second series pilot pair, P₂₅ and P₋₂₅, P₅₅ and P₋₅₅, has pilot value another pilot value. The pilot values of a symbol can be 1+j, −1−j, 1−j or −1−j.

Statistically, estimation of Δ is rendered more accurate by considering more pilot pairs. Set pilots with pilot value P are a first group, and pilots with pilot value −P is a second group. Sum of the differences of each pilot pair are as:

$${1}^{st} group difference = \sum [ \begin{matrix}( {P}_{5} - {P}_{- 5} ) + ( {P}_{15} - {P}_{- 15} ) + \\ ( {P}_{35} - {P}_{- 35} ) + ( {P}_{45} - {P}_{- 45} )\end{matrix} ]$$

$$set P = 1 + j , \\ {1}^{st} group difference = \begin{matrix}( 10 Δ - j 10 Δ ) + ( 30 Δ - j 30 Δ ) + \\ ( 70 Δ - j70Δ ) + ( 90 Δ - j 90 Δ ) = \\ 200 Δ - j200Δ ;\end{matrix} \\ similarly , \\ {2}^{nd} group difference = \sum \begin{matrix}\begin{matrix}[ ( {P}_{25} - {P}_{- 25} ) + ( {P}_{55} - {P}_{- 55} ) ] = \\ ( - 50 Δ + j50Δ ) + ( - 110 + j 110 Δ ) = -\end{matrix} \\ 160 Δ + j 160 Δ .\end{matrix} \\ Set {P}_{e} = {1}^{st} group difference - {2}^{nd} group difference , then \\ Δ = ( Re \{ {P}_{e} \} - Im \{ {P}_{e} \} ) / 720$$

Otherwise, if P=−1−j, then Δ=(Im{Pₑ}−Re{Pₑ})/720. The value of P is decided by a PN sequence generator.

In other embodiment of the invention, pilot values of a pilot pair are different. For example, the pilot value of P₅₅ is P, and P₋₅₅ is P*, −P* or −P. The phase difference of P and P* is 90°, P and −P* is −90°, and −P and P is 180°. To calculate Δ value of such pilot sequence is to rotate P*, −P* or −P to the quadrant as same as P first, then calculate the 1^{st} difference. To rotate P*, −P* to the quadrant as same as P may use a phase rotator, or simply exchange real and imaginary value of P* or −P*, then adjust the sign of exchanged real or imaginary value. For example, assume received P is 0.5+1.5j, thus, received P* is 0.5−1.5j. To rotate received P* is to exchange real and imaginary value to 1.5−0.5j, then adjust the sign of exchanged imaginary value from −0.5 to 0.5, then the rotated and received P* is now 1.5+0.5j, located in the quadrant as same as P. Because the phase difference between 0.5−1.5j and 1−j is the same as the phase difference between 1.5+0.5j and l+j, the rotated and received P* still preserves SFO information.

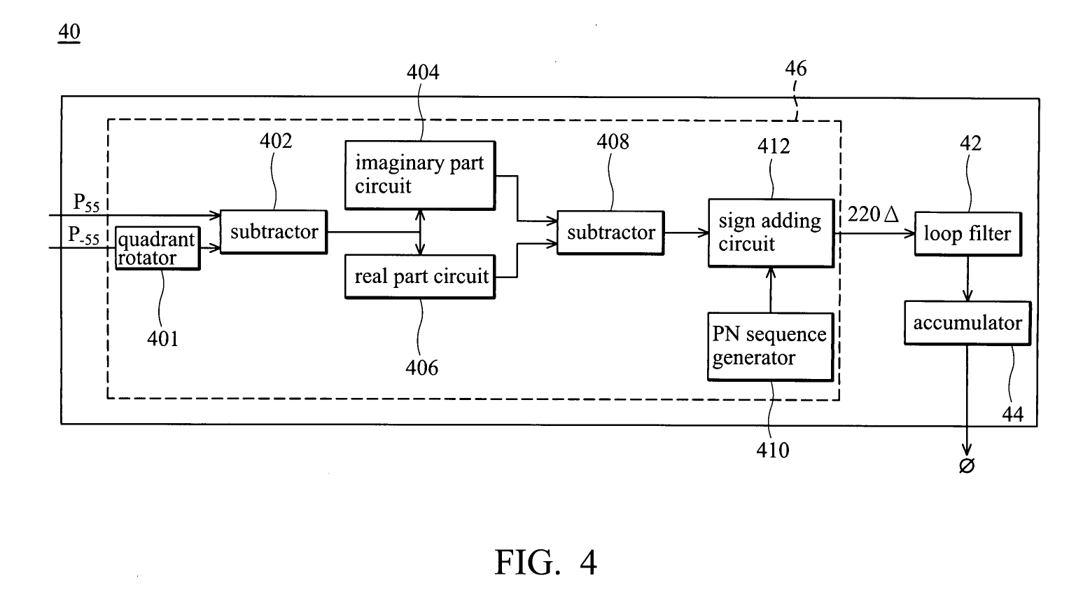

FIG. 4 is a schematic diagram of a SFO estimator in a PLL module 40. A phase rotator 401 rotates the pilot value of P₋₅₅ to the quadrant as same as P₅₅. In other embodiments of the invention, a quadrant rotator may replace phase rotator 401 for lower cost and more concise design. The output of subtractor 402 is P₅₅ minus P₋₅₅. Imaginary and real parts circuit, 404 and 406, take real and imaginary part of (P₅₅−P₋₅₅), respectively. Subtractor 408 subtracts the two parts. PN sequence generator 410 and sign adding circuit 412 adjust the result of the subtractor. The result of phase detector 46 is sent to a loop filter 42, and the filtered result fed to an accumulator 44. The output of PLL contains information of frequency offset.

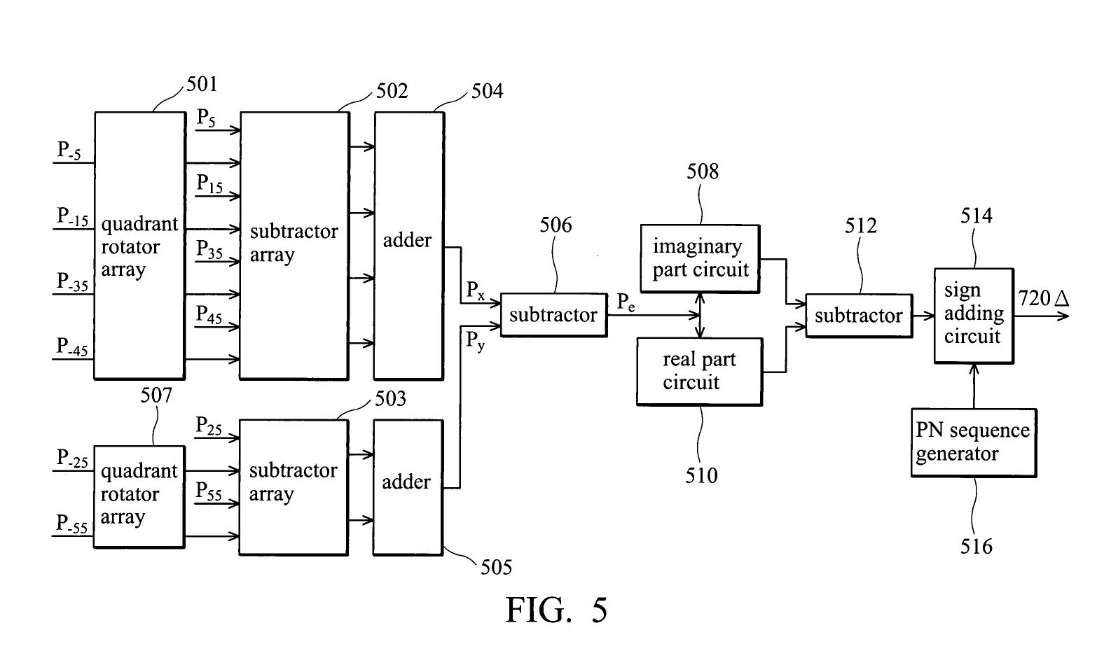

In another embodiment of the invention, the SFO estimator comprises subtractor arrays for improved performance. FIG. 5 is a structural diagram of the SFO estimator. In this embodiment, quadrant rotator array comprises 6 quadrant rotators, while subtractor arrays 502 and 503 include 6 subtractors. The subtractor arrays 502 and 503 calculate the differences for all pilot pairs. Adders 504 and 505 calculate 1^{st} group difference and 2^{nd} difference, respectively. The output of subtractor 506, Pe, is the 1^{st} group difference minus the 2^{nd} difference. Imaginary and real part circuits, 508 and 510, take real and imaginary parts of Pe. Subtractor 512 subtracts the two parts. The result of sign adding circuit 514 contains Δ information.

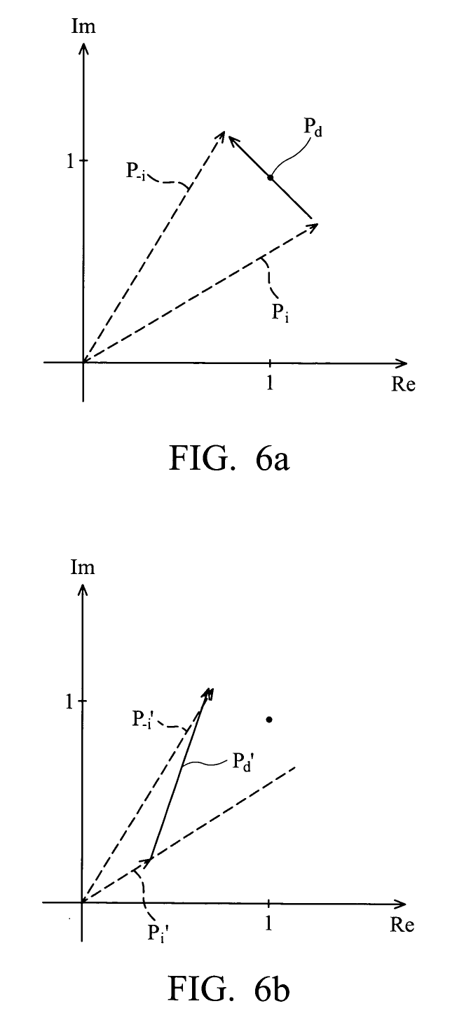

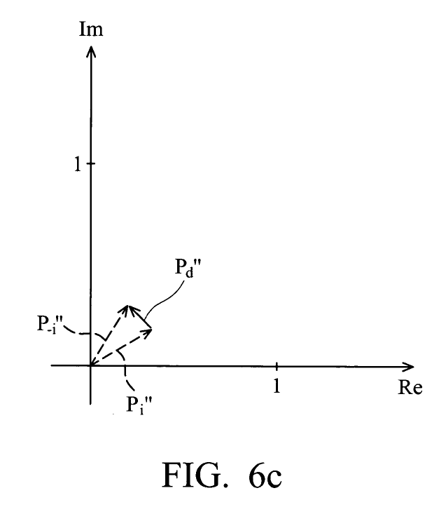

When transmitting, multi-path channel effect dramatically attenuates certain pilot power. FIG. 6a shows an ideal case in which neither pilot is attenuated. Assuming that transmitter transmits pilots Pᵢ and P₋ᵢ with pilot value 1+j, because of SFO, both pilots rotate. One rotates toward the Real axis, and the other toward the Imaginary axis. P₋ᵢ minus Pᵢ is Pd. FIG. 6b shows the case that one pilot of a pilot pair attenuated. In this case, P₋ᵢ′ minus Pᵢ′ is Pd′ and the vector of Pd′ is different from Pd. Sum of Pd′s in the summation circuit results in SFO estimation inaccuracy. FIG. 6c shows another case with both pilots attenuated. In this case, P₋ᵢ″ minus Pᵢ″ is Pd″ and vector Pd″ and Pd have substantially the same direction. Sum of Pd″s results performance degraded of SFO estimation. Fortunately, the degradation is not serious.

The invention also provides a pilot selection method to overcome multi-path effects. The pilot selection method acquires the magnitude difference of each pilot pair. If the magnitude difference of a pilot pair exceeds a pre-determined value, the pilot pair is discarded. In the embodiment of the invention, summing the absolute value of real and imaginary parts is used to approximate pilot magnitude.

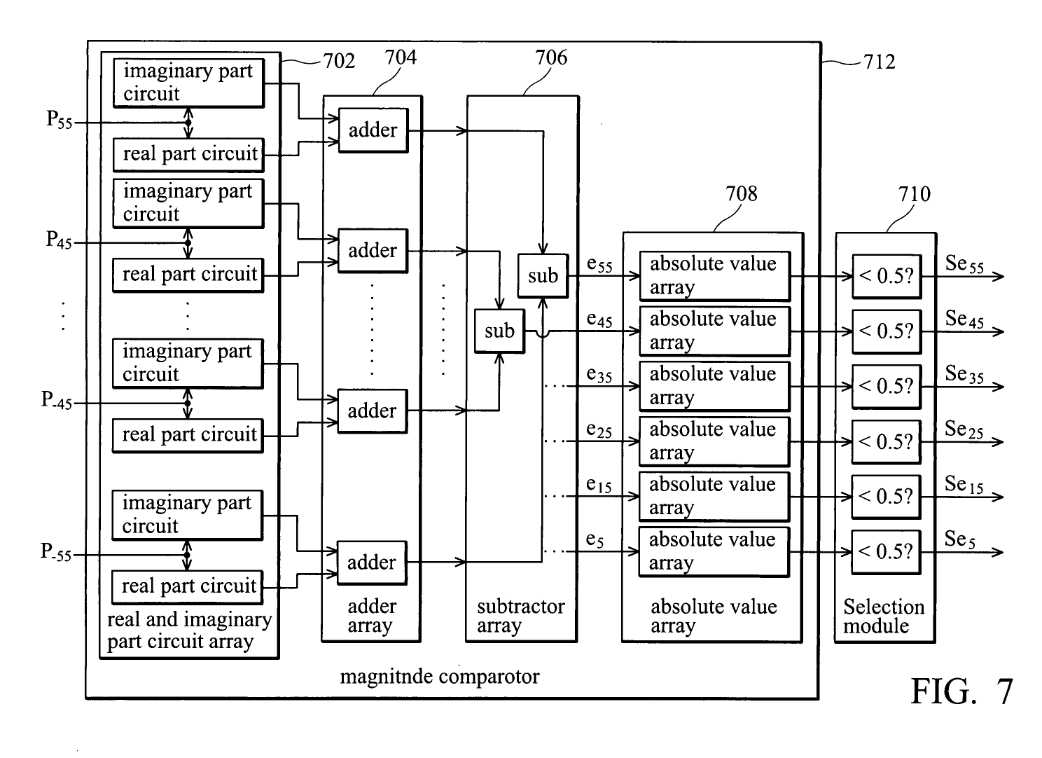

FIG. 7 is a diagram of a pilot selection module. The module compares the magnitude difference with a pre-determined value, and selects or discards pair(s) according to the magnitude difference. Imaginary and real parts array 702 acquires absolute value of real and imaginary parts of each pilot. The outputs are fed to adder array 704 to obtain magnitude approximation of each pilot. Subtractor array 706 acquires the difference of each magnitude of a pilot pair, i.e. magnitude of P₅₅ minus P₋₅₅, e₅₅, magnitude of P₄₅ minus P₋₄₅, e₄₅, etc. The absolute value array 708 generates the absolute value of the series eᵢ, where i is 5, 15, 25, 35, 45 or 55. Sub-modules 702-708 form a magnitude comparator 712. It is noted that sub-modules 702-708 are an embodiment of the invention, and other sub-modules that can perform the substantially same function of comparing magnitude 712 are also applicable in the invention. Selection module 710 outputs the result of magnitude comparison. In this embodiment, if the absolute value of eᵢ exceeds 0.5, then selection module 710 outputs a 0 to represent the pilot pair having been discarded. For instance, if |(|Re{P₂₅}|+|Im{P₂₅}|)−(|Re{P₋₂₅}|I+|Im{P₂₅}|)|>0.5, the difference between P₂₅ and P₋₂₅ is discarded, such that adder 505 does not consider the difference of P₂₅ and P₋₂₅. Conversely, if |(|Re{P₂₅}|+|Im{P₂₅}|)−(|Re{P₋₂₅}|+|Im{P₋₂₅}|)|<0.5, the difference between P₂₅ and P₋₂₅ is selected. It is noted that no multiplier or square calculator is required for pilot selection. In other embodiment of the invention, the threshold of absolute value of eᵢ is substantially between 0.5 and 1, depending on condition of channel and received power strength.

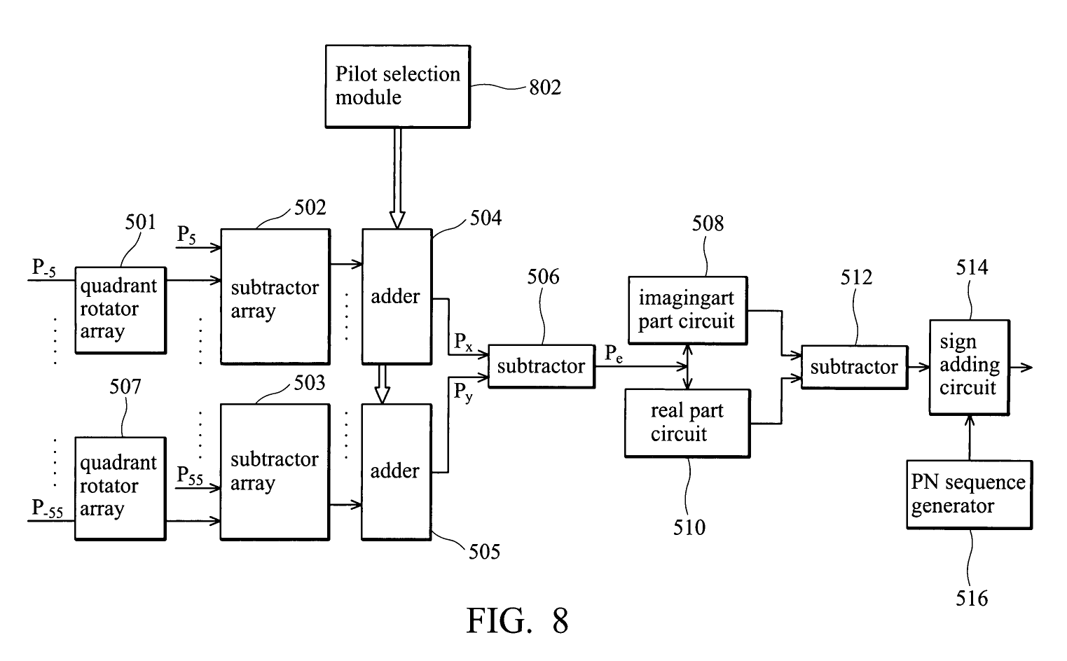

FIG. 8 is a diagram of pilot selection hardware combined with a SFO estimator. The architecture is similar to FIG. 5, except that a pilot selection module 802 is added. The output of pilot selection Se₅, Se₁₅, Se₂₅ . . . , etc. is sent to summation circuits 504 and 505 to control the result of 1^{st} group difference and 2^{nd} group difference. For example, if e₅, e₁₅, e₂₅, e₃₅, e₄₅, e₅₅ are 0.1, 0.3, 0.6, 0.7, 0.2, 0.3, respectively, then S₂₅ and S₃₅ are 0s, the others are 1s. That is 1^{st} group difference=Σ[(P₅−P₋₅)+(P₁₅−P₁₅)+(P₄₅−P₋₄₅)], and 2^{nd} group difference Σ(P₅₅−P₋₅₅).

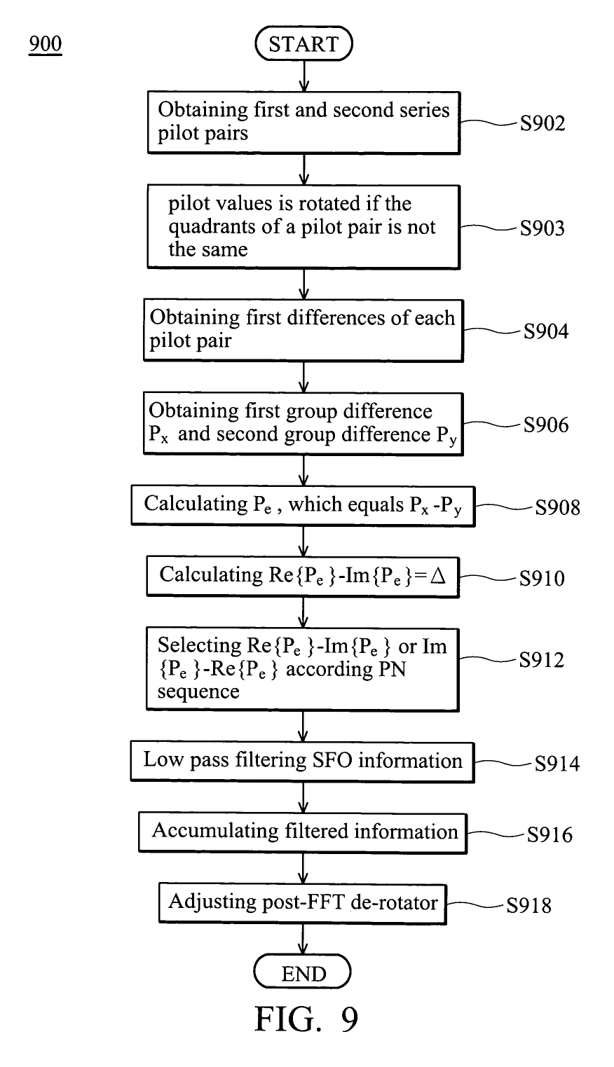

FIG. 9 is a flowchart of a method 900 for estimating SFO according to an embodiment of the invention. After obtaining an OFDM symbol in frequency-domain, first and second series pilot pairs are obtained (S902). In the embodiment of the invention, Ultra Wide Band (UWB) standard is adapted. In UWB standard, there are 12 pilots in an OFDM symbol. First series pilot pair, P₅ and P₋₅, P₁₅ and P₋₁₅, P₃₅ and P₋₃₅, and P₄₅ and P₋₄₅, have a first pilot value P, while P₂₅ and P₋₂₅, P₅₅ and P₋₅₅ have a second pilot value. In step S903, pilot values is rotated if the quadrants of a pilot pair is not the same. In step S904, first differences of each pair pilot are obtained, wherein first difference of Pᵢ pair is Pᵢ−P₋ᵢ. Next, 1^{st} group difference and 2^{nd} group difference are obtained (S906), wherein 1^{st} group difference=Σ[(P₅−P₋₅)+(P₁₅−P₋₁₅)+(P₃₅−P₋₃₅)+(P₄₅−P₋₄₅)], and 2^{nd} group difference=Σ[(P₂₅−P₂₅)+(P₅₅−P₅₅)]. In step S908, a third group difference Pₑ is obtained by 1^{st} group difference−2^{nd} group difference. In step S910, the difference between real and imaginary parts of Pₑ are obtained. Then, 1^{st} group difference−2^{nd} group difference or 2^{nd} group difference−1^{st} group difference is determined according to a PN sequence. In step S914, the information of SFO is low pass filtered. Low pass filtered information is accumulated (S916), and a post-FFT de-rotator is adjusted according there to (S918).

In other embodiments of the invention, the second series pilot pair are all zeros. Thus, there is no second group difference, and third group difference equals first group difference. In this embodiment, the performance of SFO estimation is degraded, but hardware complexity is also reduced.

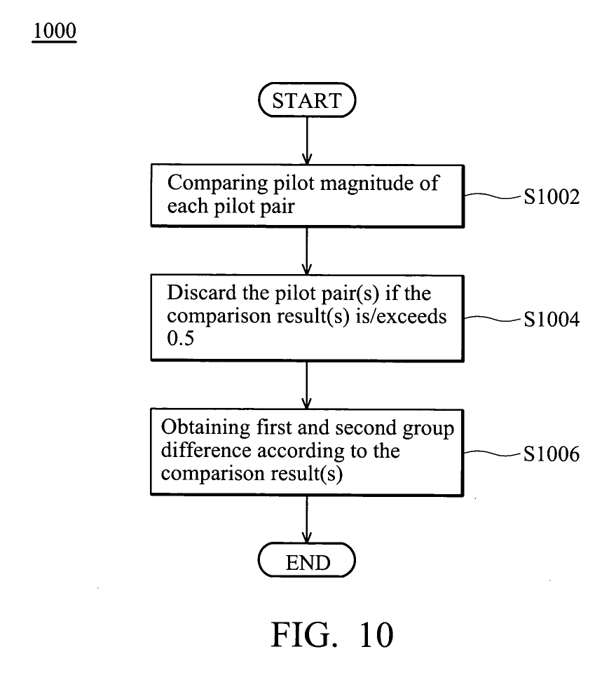

FIG. 10 is a flowchart of a pilot selection method 1000 according to embodiments of the invention. In step S1002, pilot magnitude of each pilot pair is compared. In step S1004, if the comparison results exceeds 0.5, pilot pair(s) are discarded. First and second group differences are acquired according to the comparison results obtained (S1006). In this embodiment of the invention, method 900 can collaborate with method 1000 using method 1000 to perform step S906 of method 900.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for obtaining sampling frequency offset (SFO) of an Orthogonal Frequency Division Multiplexed (OFDM) symbol in an OFDM receiver, comprising:
obtaining a frequency-domain pilot pair of the OFDM symbol, wherein the pilot pair is symmetric with a dc point of a frequency axis, and the pilot pair has the same pilot value; and
obtaining a first difference between the pilot pair;
obtaining SFO information according to a difference between real and imaginary parts of the first difference.

2. The method as claimed in claim 1, further comprising:
low pass filtering the SFO information;
accumulating the low pass filtered information; and
adjusting a post fast Fourier transform (FFT) de-rotator accordingly.

3. The method as claimed in claim 1, further comprising determining whether −1 or +1 is to be multiplied by the SFO information according to the pilot value.

4. A method for obtaining sampling frequency offset (SFO) of an Orthogonal Frequency Division Multiplexed (OFDM) symbol in an OFDM receiver, comprising:
obtaining a first series of pilot pairs, wherein each pilot pair is symmetric with a dc point of a frequency axis;
obtaining a first difference for each pilot pair;
obtaining a first group difference by summing the first differences of the first series; and
obtaining a first SFO information according to a difference between real and imaginary parts of the first group difference.

5. The method as claimed in claim 4, further comprising:
acquiring a second series of pilot pairs, wherein each pilot pair is symmetric with the dc point of the frequency axis, and each pilot pair has a second pilot value, and a ratio of the first pilot value to the second pilot value is −1;
obtaining the first difference for each pair of the second series;
obtaining a second group difference by summing the first difference of the second series;
obtaining a third group difference between the first and the second group difference; and
obtaining a second SFO information between real and imaginary part of the third group difference.

6. The method as claimed in claim 5, further comprising:
when the quadrants of a pilot pair located are not the same, rotating the negative-frequency pilot to the quadrant as same as the positive-frequency pilot.

7. The method as claimed in claim 6, wherein the first and second pilot values are determined by a PN sequence.

8. The method as claimed in claim 7, further comprising multiplying +1 or −1 to the SFO information according to the PN sequence.

9. The method as claimed in claim 5, further comprising:
comparing pilot magnitude of each pilot pair of the first and second series;
discarding the pilot pair(s) if the result of comparison exceeds a pre-determined value; and
obtaining the first and second group difference according to the comparison results.

10. The method as claimed in claim 9, wherein the pre-determined value is substantially between 0.5 and 1.

11. The method as claimed in claim 4, further comprising:
low pass filtering the first SFO information;
accumulating the low pass filtered information; and
adjusting a de-rotator accordingly.

12. A system for obtaining sampling frequency offset (SFO) of an Orthogonal Frequency Division Multiplexed (OFDM) symbol in an OFDM receiver, comprising:
a first subtractor calculating a first difference between a pilot pair, wherein the pilot pair is symmetric with a dc point of a frequency axis, and the pilots have the same pilot value;
a first processing unit obtaining a real and imaginary parts of the first difference, respectively; and
a second subtractor calculating SFO information, wherein the SFO information is a difference between the real and imaginary parts of the first difference.

13. The system as claimed in claim 12, further comprising:
a low pass filter filtering the SFO information;
an accumulator accumulating the low pass filtered information; and
a de-rotator adjusted accordingly.

14. The system as claimed in claim 12, further comprising a multiplier multiplying 1 or −1 by the SFO information according to the pilot value.

15. A system for obtaining sampling frequency offset (SFO) of an Orthogonal Frequency Division Multiplexed (OFDM) symbol in an OFDM receiver, comprising:
a first subtractor array processing a first series of pilot pairs by calculating the difference for each pilot pair, wherein the positive-frequency pilots of the pilot pairs have a first pilot value and each pilot pair is symmetric with a dc point of a frequency axis;
an first adder summing the first differences to acquire a first group difference;
a first processing unit acquiring real and imaginary parts of the first group difference, respectively; and
a second subtractor generating SFO information, wherein the SFO information is the difference between real and imaginary parts of the first group difference.

16. The system as claimed in claim 15, further comprising:
a second subtractor array processing a second series pilot pair by calculating the difference for each pilot pair of the second series, wherein each pair of the second series is symmetric with the dc point of the frequency axis, and each pilot pair of the second series has a second pilot value, and a ratio of the first pilot value to the second pilot value is −1;
a second adder summing the first differences of the second series to get a second group difference; and
a third subtractor calculating the difference between the first group difference and second group difference to get a third group difference,
wherein the third subtractor is coupled to the first processing unit such that the first processing unit acquiring real and imaginary parts of the third group difference, respectively.

17. The system as claimed in claim 16, further comprising a phase rotator array, wherein the phase rotator array rotates the negative-frequency pilots to the quadrant as same as the positive-frequency pilot when the quadrants of the pilot pairs are not the same.

18. The system as claimed in claim 17, wherein the phase rotator array is a quadrant rotator array, and the quadrant rotator array exchanges the real and imaginary values of the negative-frequency pilots, then adjusts the signs of exchanged real or imaginary values according to positive-frequency pilots.

19. The system as claimed in claim 16, further comprising a sign adding circuit to multiply 1 or −1 by the SFO information according to the first and second pilot values.

20. The system as claimed in claim 16, further comprising:
a low pass filter filtering the SFO information;
a accumulator accumulating the filtered SFO information; and
a de-rotator adjusted accordingly.

21. The system as claimed in claim 16, further comprising:
a pilot selection module, comprising:
a magnitude comparator comparing pilot magnitude of each pilot pair; and
a selection module selecting or discarding pilot pair(s) according to the output of the magnitude comparator,
wherein the first and second adders calculate the group differences of selected pairs of the first and second series, respectively.

22. The system as claimed in claim 20, wherein the magnitude comparator comprising:
an adder array, wherein each adder sums absolute values of real and imagery parts of one pilot;
a third subtractor array taking magnitude difference for each pilot pair; and
a absolute value array taking absolute value for each magnitude difference.

23. The system as claimed in claim 16, further comprising a PN sequence generator determining the first and second pilot values.
